(19) United States
(12) Patent Application Publication
(10) Pub. No.: US 2012/0300291 A1
(43) Pub. Date: Nov. 29, 2012

(54) METAL REFLECTORS

(76) Inventor: James Abbott, Albany, OR (US)

(21) Appl. No.: 13/114,809

(22) Filed: May 24, 2011

(51) Int. Cl. G02B 5/08; B05D 5/12; H05H 1/24

(52) U.S. Cl. 359/360; 359/883; 427/535; 427/74

(57) ABSTRACT

In one example, a metal reflector includes a silver layer and an underlying metal layer in galvanic communication with the silver layer.

### BACKGROUND

Reflective metal coatings can be used to collect and concentrate light in a variety of applications, including solar heating and solar power generation. The metal coatings can have a high reflectivity over a broad range of optical wavelengths. However, the metal coatings can be fragile and susceptible to chemical corrosion.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a graph showing the reflectance of aluminum and silver films over a range of the optical spectrum, according to one example of principles described herein.

FIG. 2 is a cross sectional diagram of an illustrative chemically protected high reflectivity metal reflector on a polymer substrate, according to one example of principles described herein.

FIG. 3 is a flowchart showing an illustrative method for creating a chemically protected high reflectivity metal reflector on a polymer substrate, according to one example of principles described herein.

FIGS. 4A-4D are cross sectional diagrams of illustrative chemically protected high reflectivity metal reflectors, according to one example of principles described herein.

Throughout the drawings, identical reference numbers designate similar, but not necessarily identical, elements.

### DETAILED DESCRIPTION

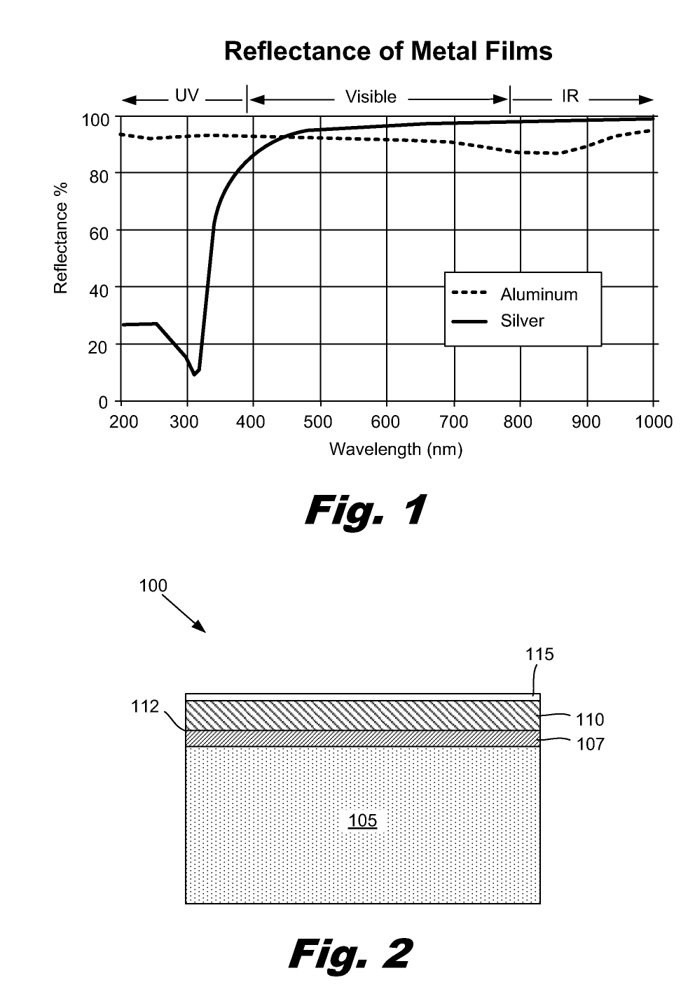

FIG. 1 is a graph showing the reflectance of aluminum and silver films over a portion of the optical spectrum. The horizontal axis of the graph shows the optical wavelength in nanometers, beginning at 200 nanometers and ending at 1000 nanometers. The ultraviolet (UV), visible, and infrared (IR) wavebands are shown along the top of the graph. The UV waveband begins at approximately 100 nanometers and extends to approximately 400 nanometers. Only a portion of the UV waveband is shown on the graph. The visible waveband extends from about 380 nanometers to 780 nanometers. The IR waveband extends from about 700 nanometers to 1 millimeter. Only a small portion of the IR waveband is shown. For solar heating and solar power applications, reflectance of reflective metal films in the wavebands where most of the solar energy is present can be of particular interest. The highest spectral irradiance of the solar spectrum occurs at about 500 nanometers, with a large portion of the solar energy lying between 250 nanometers and 1000 nanometers. Lower levels of infrared light in the solar spectrum extend into the infrared spectrum following a black body curve at approximately 5250° C.

The vertical axis shows the reflectance in percent of the incident light. Silver has relatively low reflectance in the UV band. For example, silver has a reflectance of approximately 25% at 200 nanometers and a reflectance of only 10% at about 320 nanometers. Sunlight contains a significant amount of UV energy between 200 and 320 nanometers. A silver layer will either absorb or transmit a large portion of this UV energy. The reflectance of silver rapidly increases in the visible waveband to about 85% at 400 nanometers to greater than 95% at 800 nanometers. The reflectance of silver continues to increase for longer wavelengths.

The reflectance of aluminum is much higher than silver for short UV wavelengths and decreases in the visible waveband to a minimum between 800 and 900 nanometers. The reflectance of aluminum then increases through the infrared waveband.

A silver reflector has a number of desirable characteristics, including high reflectivity in the visible and IR wavebands. As discussed above, most of the energy in sunlight is contained in these wavebands. Consequently, a silver based reflector can be more effective than aluminum reflectors in directing and concentrating sunlight. However, silver is susceptible to chemical corrosion. For example, silver tarnishes when exposed to ozone or sulfur compounds such as hydrogen sulfide. Tarnishing is a chemical reaction that produces a dull, gray, or black film over the silver. This severely reduces the reflectance of the silver film.

Metal reflective films are typically deposited on a supporting substrate. The substrate may provide a number of benefits, including reducing the overall cost of the reflector compared to a reflector which is made from solid metal and contributing mechanical characteristics which the metal film may not possess.

Polymers have a wide range of properties and are used in a variety of applications. However, polymers are susceptible to varying degrees to ultra violet radiation and have varying levels of gas and liquid permeability. Relatively thin polymer films, such as those thinner than 500 microns may be more mechanically susceptible to ultraviolet radiation than thicker films. Ultraviolet radiation causes bonds between the polymers to break, resulting in a loss of strength and flexibility. Additionally, the thinner the polymer film, the easier gas and liquid can permeate the film.

When a polymer film is used as a substrate for a reflector, gasses and liquids can undesirably permeate through the film and corrode the back surface of the reflective metal film. This can result in chemical attack on the metal film and the loss of reflectivity of the reflector. Additionally, if the reflective metal film transmits ultraviolet light, the underlying polymer film can be damaged the ultraviolet light which passes through the reflective metal film and strikes the substrate. The ultraviolet light can weaken the mechanical structure of the substrate, making it more permeable to gasses and liquids.

Because of the weakness of silver films to chemical attack and transmission of UV light, silver films are not typically used on polymer substrates in outdoor applications, despite the high initial reflectance of the silver films. However, the following example structures and methods for using silver films in conjunction with polymer substrates solve corrosion, permeability, and UV issues typically present in silver coated polymer reflectors.

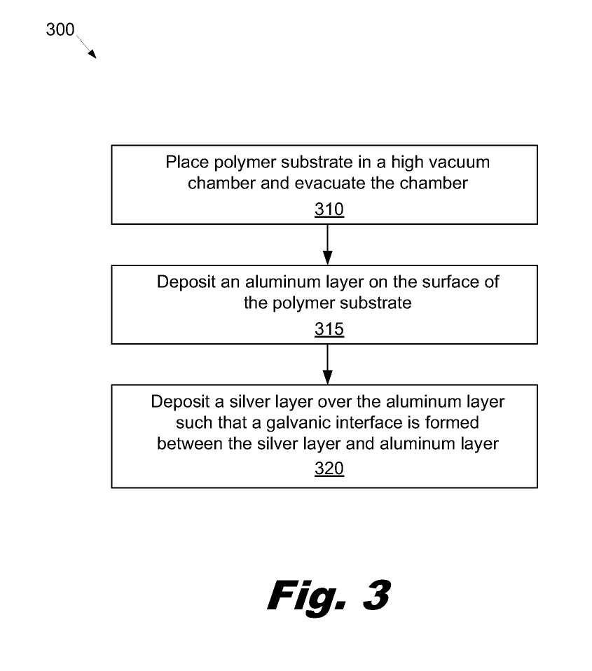

FIG. 2 is a cross sectional diagram of an illustrative chemically protected high reflectivity metal reflector (100) on a polymer substrate. The polymer substrate (105) may provide a number of benefits including flexibility and the ability to shape the reflector in a wide range of geometries. In one implementation, the polymer substrate (105) is formed from polyethylene naphthalate (PEN), polyethylene terephthalate (PET) or other suitable polymer materials. The polymer substrate (105) may have a wide range of thicknesses. In one example, the polymer substrate (105) has a thickness which is greater than 25 microns. For example, the polymer thickness may be between 25-500 microns or between 100-300 microns. The thickness of the polymer can be selected to suit the application. In some implementations, the polymer substrate thickness may be several millimeters or more.

An aluminum layer (107) is deposited over the polymer substrate (105). The thickness of the aluminum layer (107) is typically greater than 500 angstroms. The thickness of the aluminum layer (107) is selected to provide uniform coverage over the upper surface of the polymer substrate and a barrier against gas and liquid which may pass through the polymer substrate. For example, the aluminum layer may have a thickness which is between 500 angstroms and several microns in thickness. In other examples, the aluminum layer (107) may also serve to mechanically support the reflector and may be as thick as required to provide the desired rigidity.

A silver layer (110) is deposited directly over the aluminum layer (107) so that the silver layer (110) is in mechanical and electrical contact with the aluminum layer (107). According to one illustrative example, the thickness of the silver layer (110) is greater than approximately 1000 angstroms. For example, the thickness of the silver layer may be between 1000 angstroms and several microns. As discussed above, the silver layer (110) has superior reflectance in the visible spectrum and portions of the IR spectrum. However, silver layer (110) is susceptible to chemical attack. The aluminum layer (107) protects the silver layer (110) in at least three ways. First, the aluminum layer (107) is a very effective barrier against corrosive gas or liquids which may permeate the polymer substrate (105). These corrosive gases or liquids may interact with the aluminum layer (107) and form aluminum oxide or other stable compound. The aluminum oxide is a stable compound which resists further corrosion and continues to be an effective barrier against gasses or liquids which penetrate the polymer substrate.

Second, the aluminum layer (107) protects the polymer substrate (105) from UV light which may pass through the silver layer (110) by reflecting the UV light back into the silver layer (110). As discussed above, aluminum layer (107) has a high reflectance in the UV region. Consequently, almost all of the UV light which is transmitted through the silver layer (110) is blocked by the aluminum layer (107). This prevents degradation of the polymer substrate (105) by UV light which passes through the silver layer (110) and maintains the polymer substrate's properties as a mechanical support and partial barrier to outside contaminants. Additionally, in cases where the silver layer (110) is relatively thin, the underlying aluminum layer (107) may significantly increase the UV reflectance of the reflector.

Third, the aluminum layer (107) acts as an electron donor to chemically protect the silver layer (110). Aluminum has a standard reduction potential of approximately −1.6 Volts while silver has a standard reduction potential of 0.8 Volts. This difference in reduction potential indicates that the aluminum layer (107) will act as a cathode and donate electrons to the silver layer (110) to chemically protect the silver from oxidization when there is a galvanic interface between the aluminum and silver layers (107, 110). As used in the specification and appended claims, the term “galvanic interface” or “galvanic communication” refers to bonding between two materials with different reduction potentials such that a sacrificial metal donates electrodes to a protected metal to prevent corrosion of the protected metal. In this implementation, the aluminum acts as the sacrificial metal and the silver is the protected metal. For example, when corrosive molecules, such as ozone or sulfur compounds, encounter the silver layer (110), they strip electrons from the silver layer (110). Ordinarily, this would result in chemical bonding between the corrosive element and the sliver layer (110). However, because the aluminum layer (107) readily provides electrons to the silver layer (110) through galvanic action, the silver layer (107) does not bind with the corrosive molecules and is not corroded.

A protective overcoat (115) is provided over the upper surface of the silver layer (110). This protective overcoat (115) may be formed from a variety of materials and layers. For example, the protective overcoat (115) may include aluminum oxide, magnesium fluoride, titanium oxide, silicon oxide, oxygen depleted silicon oxide, chromium nitride or other suitable materials. The composition, thickness, and structure of the protective overcoat (115) can be selected to provide the desired barrier between the exterior environment and the silver layer (110) while maintaining the desired reflectivity.

The structures and materials given above are only illustrative examples. A variety of other configurations could also be used. For example, the aluminum layer (107) could be replaced by other materials which would provide similar galvanic protection to silver. Taking into account only the differences in standard reduction potential between silver and the galvanic layer, other galvanic materials may include magnesium, beryllium, manganese, zinc, chromium, iron, cadmium, nickel and copper. Other considerations, such as oxide stability, bonding, optical properties, or other factors may be used to make a determination of which galvanic material would be optimum for a given application.

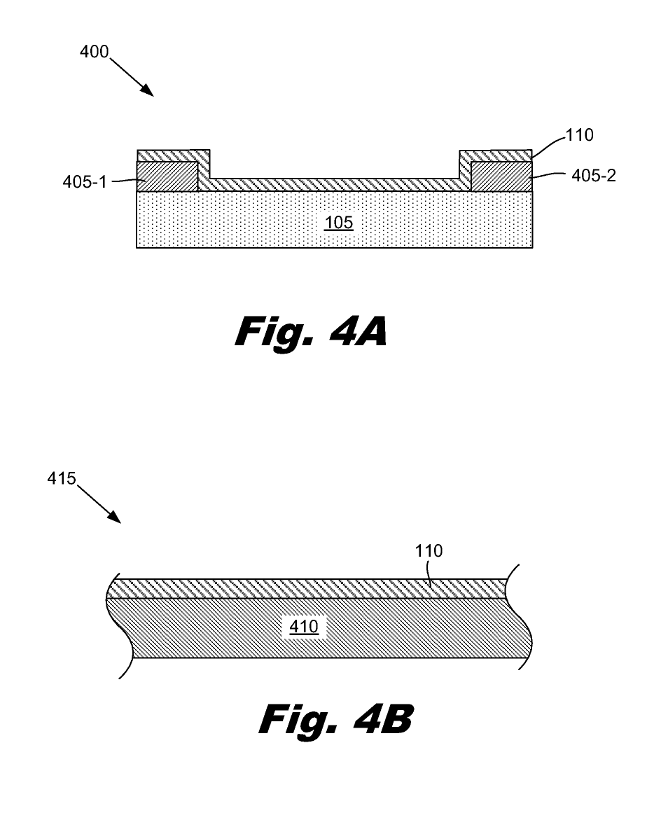

FIG. 3 is a flow chart of an illustrative method for forming a chemically protected high reflectivity metal based reflector on a polymer substrate. The polymer substrate is placed in a high vacuum chamber which is evacuated (block 310). In one implementation the high vacuum chamber is pumped down to 10⁻⁷ to 10⁻⁸ Torr. This reduces the number oxygen and water vapor molecules which could react with the silver and aluminum which will be deposited. In some embodiments, the polymer substrate may be subjected to plasma treatment prior to deposition of the metal films. For example, this plasma treatment may be an argon plasma treatment. The energy and duration of the plasma treatment may be adjusted to achieve the desired surface cleaning and surface energy of the polymer substrate.

The aluminum layer is then deposited on a surface of the polymer substrate (block 315) while the vacuum in maintained in the chamber. The aluminum layer may be deposited in a variety of ways including evaporation and sputtering. As discussed above, the thickness of the aluminum layer is great enough to provide uniform coverage over the upper surface of the polymer substrate and a barrier against gas and liquid which may pass through the polymer substrate. For example, the aluminum layer may have a thickness that is greater than 500 angstroms.

The silver layer is deposited over the aluminum layer such that a galvanic interface is formed between the silver layer and the aluminum layer (block 320). The silver layer may be deposited using any appropriate vacuum deposition technique. For example, the silver layer may be deposited by thermal evaporation, sputtering, pulsed laser deposition, or other appropriate process. According to one example, the silver layer is deposited over the aluminum without a break or substantial reduction in the vacuum. This ensures that the highly reactive aluminum surface is not contaminated/oxidized prior to the deposition of the silver and that a galvanic interface is formed between the two layers. As discussed above, the thickness of the silver layer may be greater than 1000 angstroms in some examples. For example, the thickness of the silver layer may be selected by balancing factors such as reflectance, cost, flexibility, deposition times, or other factors. In some examples, the silver layer may be thinner than 1000 angstroms to facilitate UV reflection by the underlying aluminum layer.

The examples and blocks given above are only illustrative examples. Blocks could be added, combined, reordered or eliminated. For example, the polymer substrate may be degassed prior to deposition of the reflective films. This removes oxygen, water, and other volatile components from the polymer substrate. For example, this polymer substrate may be placed in a vacuum and heated. This causes the volatile components to outgas into the vacuum. Additionally, a protective overcoat can be deposited on the exposed surface of the silver layer. The protective overcoat may be deposited using any appropriate technique, including physical vapor deposition or chemical vapor deposition techniques. As discussed above the protective overcoat may include a variety of materials and structures. A variety of chemically resistant, transparent materials and structures can be selected for a given application. For example, a silicon oxide overcoat may be used to decrease chemical attach of the silver from the top.

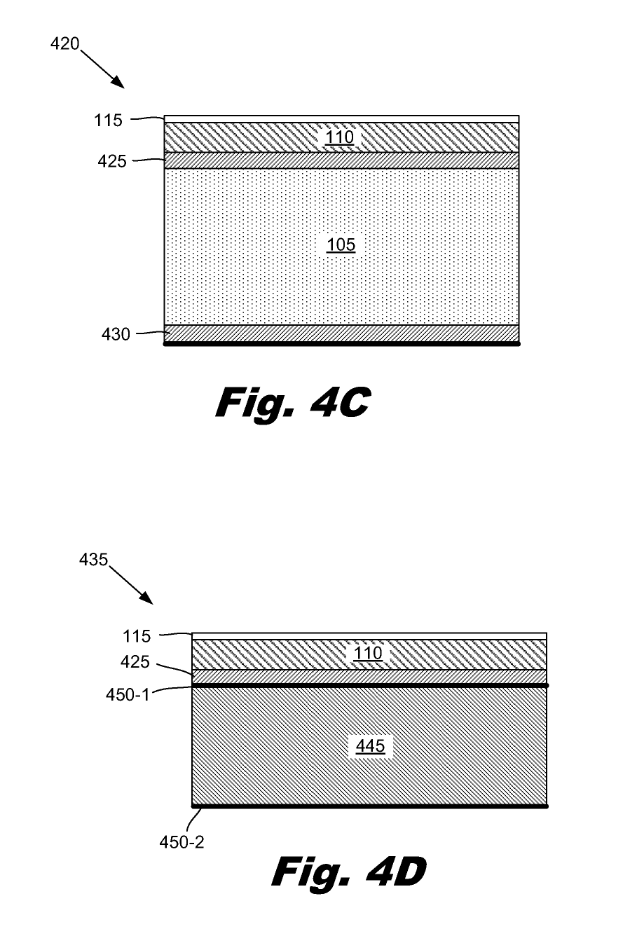

FIGS. 4A-4D are cross sectional diagrams of illustrative chemically protected high reflectivity metal reflectors. FIG. 4A illustrates the principle that a sacrificial metal (405) layer does not have to underlie the entire area of the reflective metal layer (110) to provide galvanic protection to a reflector (400). In this example, the sacrificial metal layer (405) has been patterned into two islands on the substrate (105). A variety of other patterns could be used. The deposition and patterning could be accomplished in a variety of ways, including using shadow masking in a deposition chamber to form the patterned sacrificial layer (405), followed by deposition of the reflective metal layer (110) over the patterned sacrificial layer (405) in the deposition chamber. As discussed above, this forms a galvanic interface between the sacrificial metal layer (405) and the reflective metal layer (110).

Alternatively, a layer of aluminum (which acts as the sacrificial layer) could be deposited in a deposition chamber, removed from the deposition chamber for patterning into the islands (405), and then returned to the deposition chamber for removal of the aluminum oxide from the surface of the islands (405). The reflective silver layer (110) is then deposited over the patterned aluminum layer (405) and substrate (105) to form a galvanic interface.

The islands (405) of sacrificial metal provide galvanic protection by donating electrons to the reflective metal layer (110). These electrons can be conducted from the galvanic interface to any location in the reflective metal layer (110). For example, silver has a very high electrical conductivity and can readily transport electrons to fill vacancies caused by corrosive compounds at locations away from the islands (405) of sacrificial metal.

FIG. 4B is a cross sectional diagram of a galvanically protected reflector (415) which includes a reflective metal layer (110) that is directly deposited on a sacrificial metal substrate (410). For example, the sacrificial metal substrate (410) may be aluminum foil or sheet. The aluminum foil or sheet can be placed in a vacuum chamber and the native oxide removed. The reflective silver layer (110) can then be deposited directly on the clean surface of the aluminum (410) to form a galvanic interface. As discussed above, the thickness of the aluminum (410) can be selected to provide the desired structural support for the reflector.

FIG. 4C is a diagram of an illustrative reflector (420) that includes a polymer substrate (105) with two layers of aluminum (425, 430) deposited on either side. The aluminum layers (425, 430) serve as barriers to gases and liquids. Over the upper aluminum layer (425), the silver reflective layer (110) and protective overcoat (115) are deposited. As discussed above, the upper aluminum layer (425) galvanically protects the silver reflective layer (110) from chemical attack. The additional lower layer (430) of aluminum oxidizes as a result of its exposure to the environmental conditions. As discussed above, aluminum oxide is a very stable compound which can increase the chemical and barrier properties of the layer (430).

FIG. 4D is a diagram of an illustrative reflector (435) which includes an aluminum substrate (445) which has not been stripped of its native oxide layers (450). In the vacuum chamber, an additional layer of aluminum (425) has been deposited directly on the upper oxide layer (450-1). The silver reflective layer (110) is then deposited over the aluminum layer (425) and forms a galvanic interface with the newly deposited aluminum layer (425). A protective overcoat (115) is deposited over the silver reflective layer (110).

In conclusion, a silver reflective layer can be chemically protected by an underlying metal layer which is in galvanic communication with the silver layer. The underlying metal layer may also serve as mechanical barrier between the silver layer and a polymer substrate to prevent gasses and liquids which penetrate the polymer substrate from contacting the silver layer. This configuration increases the robustness and maintains the reflectivity of the silver layer over extended periods of time.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A reflector comprising:
a silver layer; and
an underlying metal layer in galvanic communication with the silver layer.

2. The reflector of claim 1, in which the underlying metal layer has a standard reduction potential which is lower than a standard reduction potential of silver.

3. The reflector of claim 1, in which the underlying metal layer is aluminum.

4. The reflector of claim 1, further comprising a protective overcoat deposited over the silver layer.

5. The reflector of claim 1, further comprising a polymer substrate.

6. The reflector of claim 5, in which the polymer substrate comprises one of: polyethylene naphthalate (PEN) and polyethylene terephthalate (PET).

7. The reflector of claim 5, in which the polymer substrate has a thickness between 25 and 500 microns.

8. The reflector of claim 1, in which the underlying metal layer has a thickness of greater than 500 angstroms.

9. The reflector of claim 1, in which the silver layer has a thickness of greater than 1000 angstroms.

10. The reflector of claim 1, in which the underlying metallic layer provides galvanic protection to the silver layer against chemical attack.

11. The reflector of claim 5, in which the underlying metallic layer forms a mechanical barrier between the polymer substrate and the silver layer to prevent diffusion of permeates through the polymer substrate from reaching the silver layer.

10. An optical system comprising a reflector for reflecting incident radiation comprising a UV component, a visible component, and an IR component, the reflector comprising a silver layer and an underlying aluminum layer in galvanic communication with the silver layer.

11. The system of claim 10, in which the silver layer reflects a portion of the visible component and IR component and at least a portion of the UV component of the incident radiation passes through the silver layer and is reflected by the underlying aluminum layer.

12. The system of claim 10, further comprising a polymer substrate, the aluminum layer being deposited on the substrate.

13. The system of claim 12, in which the aluminum layer blocks contaminates which permeate through the polymer substrate from reaching the silver layer.

14. The system of claim 10, further comprising a silicon oxide protective overcoat deposited on an upper surface of the silver layer.

15. The system of claim 10, further comprising a corrosive compound in contact with the silver layer, the corrosive compound stripping electrons from the silver layer and the underlying aluminum layer in galvanic communication with the silver layer to supply electrons to the silver layer to replace the electrons stripped from the silver layer.

16. A method for forming a chemically protected high reflectivity metal based reflector on a polymer substrate comprising:
placing the polymer substrate in a vacuum chamber and evacuating the high vacuum chamber to form a vacuum;
depositing an aluminum layer on the polymer surface while a vacuum is maintained in the chamber; and
depositing a silver layer over the aluminum layer while maintaining the vacuum in the chamber, in which a galvanic interface is formed between the silver layer and the aluminum layer.

17. The method of claim 16, further comprising degassing the polymer substrate.

18. The method of claim 16, further comprising subjecting the polymer substrate to plasma treatment.

19. The method of claim 16, in which degassing the polymer substrate comprises placing the polymer substrate in a vacuum and heating the polymer substrate.

20. The method of claim 16, further comprising depositing a protective overcoat an exposed surface of the silver layer.
